(19) United States
(12) Patent Application Publication
(10) Pub. No.: US 2025/0270052 A1
(43) Pub. Date: Aug. 28, 2025

(54) CONVEYOR ALIGNMENT MECHANISM

(71) Applicant: TRU-TRAC ROLLERS (PTY) LTD, Sunderland Ridge, Centurion (ZA)

(72) Inventor: Hendrik Stephanus PRETORIUS, Sunderland Ridge, Centurion (ZA)

(73) Assignee: TRU-TRAC ROLLERS (PTY) LTD, Sunderland Ridge, Centurion (ZA)

(21) Appl. No.: 18/856,492

(22) PCT Filed: Apr. 11, 2023
(86) PCT No.: PCT/IB2023/053667

§ 371 Date: Oct. 11, 2024

(30) Foreign Application Priority Data
Apr. 11, 2022 (AU) 2022900965

(51) Int. Cl. B65G 39/12; B65G 15/60

(52) U.S. Cl. CPC B65G 39/125; B65G 15/60

(57) ABSTRACT

A conveyor alignment mechanism (10, 100, 200) used to guide conveyor belts (20), and typically but not exclusively, belts of trough conveyors. The conveyor alignment mechanism (10, 100, 200), comprises a mounting frame (12) for operatively mounting the conveyor alignment mechanism (10, 100, 200) to a conveyor frame and a substructure (16, 208) which is pivotably mounted to the mounting frame (12) by means of a main pivot (18). A pair of steering or wing rollers (26) are mounted relative to the substructure (16, 208) in outward-facing cantilevered fashion. Specifically, the alignment mechanism (10, 100, 200) is configured to protrude substantially no further laterally than the mounting frame (12) or the conveyor frame. In a preferred form of the invention the steering or wing rollers (26) are adjustable, with a permissible range of adjustment between about 0 degrees and about 65 degrees.

### BACKGROUND TO THE INVENTION

This application claims priority from Australian application number 2022900965 filed 11 Apr. 2022, the content of which is incorporated in its entirety herein by reference, as if repeated herein.

This invention relates to trough conveyors. More particularly, the present invention relates to trough conveyor alignment mechanisms, used to guide trough shaped conveyor belts.

A device to guide trough shaped belts typically has a central roller or rollers, and wing rollers on either side of the central roller which are angled upwards from the horizontal so as to match the profile or troughing angle of the belt.

Trough shaped conveyor belts tend to be difficult to guide or steer because the alignment or steering mechanism, in particular the wing rollers, tend to push into the belt as the mechanism seeks to align the belt. Also, trough configurations of different belts are not standard and, in particular, the troughing angle can vary from conveyor to conveyor.

Accordingly, known trough conveyor alignment mechanisms are often provided with pivotably adjustable wing rollers. The range of adjustment of these known alignment mechanisms is very limited, and the range is typically only a few degrees. Furthermore, known alignment mechanisms tend to butt out sideways from the side of the alignment mechanism, and often protrude beyond or stand proud of the conveyor frame and into maintenance walkways running along sides of the conveyor.

This may pose potential safety concerns and may inhibit the use of hoods or other covers typically employed over conveyors of this nature. Such hoods, therefore, often have to be customized in areas where alignment mechanisms are installed, which adds complexity to the installation and maintenance of the conveyor.

It is furthermore believed that the bulky construction of prior art alignment mechanisms may negatively impact the efficiency of the alignment mechanism.

It is accordingly an object of the invention to provide a trough conveyor alignment mechanism and a trough conveyor incorporating such an alignment mechanism that will, at least partially, address the above disadvantages.

It is also an object of the invention to provide a trough conveyor alignment mechanism and a trough conveyor incorporating such an alignment mechanism which will be useful alternatives to existing or known alignment mechanisms and trough conveyors.

### SUMMARY OF THE INVENTION

According to the invention there is provided an adjustment mechanism for trough conveyor belt alignment devices that protrudes substantially no further laterally than the mounting arrangement by means of which the device is mounted to a conveyor frame. In a preferred form of the invention the steering or wing rollers of the device are mounted cantilever fashion to the device frame, and the adjustment mechanism is incorporated into the cantilever mounting arrangement. Preferably the adjustment mechanism allows the wing rollers to be adjusted to an angle of 0 degrees, so that the wing rollers are substantially in the same plane as the central roller or rollers.

In accordance with a first aspect of the invention, there is provided a conveyor alignment mechanism, comprising
a mounting frame for operatively mounting the conveyor alignment mechanism to a conveyor frame;
a substructure, pivotably mounted to the mounting frame by means of a main pivot;
a pair of steering rollers mounted relative to the substructure in outward-facing cantilevered fashion.

Further in accordance with the first aspect of the invention, at least a portion of each of the steering rollers may be tapered. Each steering roller may be mounted to the subframe by means of a respective tubular bracket having a bore within which a shaft of the respective wing roller is operatively received. This tubular bracket may form part of an angle adjustment mechanism (in cases where the steering rollers are adjustable) or may be fixed relative to the substructure.

Furthermore, in some embodiments of the first aspect of the invention, each steering roller may pivotably adjustable relative to the substructure. Each steering roller may be mounted to the substructure by means of an angle adjustment mechanism. In some examples, each angle adjustment mechanism may comprise a tubular bracket with a bore within which a shaft of the respective steering roller may operatively be received and retained in cantilever fashion. The shaft of the respective steering roller may be fixed relative to the tubular bracket by means of at least a first grub screw.

Towards a first end thereof, the tubular bracket may pivotably be mounted to the substructure by means of a first pivot. An adjustable link mechanism may extend between a second end of the tubular bracket and the substructure. The adjustable link mechanism may pivotably be fixed to both the tubular bracket and the substructure by means of a second and third pivot, respectively. An effective length of the adjustable link mechanism may be adjustable, to pivot the tubular bracket about the first pivot to adjust an angle of the tubular bracket relative to substructure. The adjustable link mechanism may comprise a threaded rod with a locking nut arrangement for releasably fixing a position of the adjustable link mechanism.

Furthermore, each steering roller may be adjustable between about 0 degrees and 65 degrees relative to a plane in which the central rollers are arranged. It will be appreciated that end values of the range of adjustability may be included. Also, the specific configuration of the alignment mechanism may be such that end values of the range of adjustability may differ from those specified above. Particularly, the end values may take any value between 0 and 65 degrees and any such feasible value is therefore incorporated herein as if specifically repeated herein.

In some cases, the alignment mechanism may further comprise at least a first, but typically two central rollers arranged between the pair of steering rollers (and on opposite sides of the main pivot [in the case of two central rollers being provided]). The central roller(s) may be replaced by bearing plates.

In other cases, the alignment mechanism need not be provided with central rollers or bearing plates. In some such cases, the alignment mechanism may be configured as a return tracker and each angle adjustment mechanism may comprise:
a first pivot connected to the substructure and to a shaft of the respective steering roller;
a lever arranged pivotably relative to the substructure;
a base plate fixed relative to the substructure; and
an adjustable member extending between the lever and base plate.

Now, the adjustable member may comprise a threaded member received within a threaded bore of the lever and may have a first end arranged to bear against the base plate. The threaded member may comprise an elongate member having a second end supported relative to a distal end of the respective steering roller.

Each steering roller may be configured to be pivotably adjustable in a plane substantially perpendicular to a plane in which the substructure is pivotable about the main pivot.

In accordance with a second aspect of the invention, there is provided a conveyor alignment mechanism, comprising
a mounting frame for operatively mounting the conveyor alignment mechanism to a conveyor belt frame;
a substructure, pivotably mounted to the mounting frame by means of a main pivot;
a pair of steering rollers carried by the substructure,
a pair of angle adjustment mechanisms, each associated with a respective one of the steering rollers and comprising:
an adjustable link mechanism extending substantially vertically from a distal part of the substructure; and
an angled support plate extending between the adjustable link mechanism and a distal part of the respective steering roller.

Further according to the second aspect of the invention, the adjustable link mechanism may include a locking arrangement for locking a position thereof relative to the substructure. The adjustable link mechanism may comprise a threaded rod with a lock nut configured as locking mechanism or a rod with a plurality of longitudinally spaced holes with a locking pin configured as locking arrangement. A footprint (viewed in plan) of the substructure and pair of angle adjustment mechanisms may fall within a footprint of the mounting frame (viewed in plan).

In accordance with a third aspect of the invention, there is provided a conveyor, comprising
a main conveyor frame
a conveyor alignment mechanism according to any one of the preceding claims mounted to the main conveyor frame; and
a belt supported at least partially on the conveyor alignment mechanism.

### BRIEF DESCRIPTION OF THE DRAWINGS

The invention will now be described in more detail, by way of example only, with reference to the accompanying drawings in which:

FIG. 1 shows a front view of an alignment mechanism for a trough conveyor in accordance with an aspect of the invention;

FIG. 2 shows a top view of the alignment mechanism of FIG. 1;

FIG. 3 shows a side view of the alignment mechanism of FIG. 1;

FIG. 4 shows a perspective view of the alignment mechanism of FIG. 1;

FIG. 5 shows a sectioned front view of the alignment mechanism of FIG. 1;

FIG. 6 shows a detailed view of an angle adjustment mechanism forming part of the alignment mechanism of FIG. 1;

FIG. 7 shows a partial perspective view of the angle adjustment mechanism shown in FIG. 6, with some components omitted to show specific detail;

FIG. 8 shows a partial front view of the angle adjustment mechanism shown in FIGS. 6 and 7, again with some components omitted to show specific detail;

FIG. 9 shows an exploded partial front view of another embodiment of the angle adjustment mechanism of FIGS. 6 to 8;

FIG. 10 shows a perspective view of the angle adjustment mechanism of FIG. 9;

FIG. 11 shows a top view of the angle adjustment mechanism of FIG. 9;

FIG. 12 shows a front view of a return alignment mechanism for a conveyor in accordance with an aspect of the invention;

FIG. 13 shows a top view of the return angle adjustment mechanism of FIG. 12;

FIG. 14 shows a partial front view of the return angle adjustment mechanism of FIG. 12;

FIG. 15 shows a partial detailed front view of the angle adjustment mechanism of FIG. 12;

FIG. 16 shows a perspective view of the return angle adjustment mechanism of FIG. 12;

FIG. 17 shows a partial detailed perspective view of the return angle adjustment mechanism of FIG. 12;

FIG. 18 shows a front view of an alternative embodiment of the return angle adjustment mechanism of FIG. 12;

FIG. 19 shows a front view of an alignment mechanism according to an alternative aspect of the invention;

FIG. 20 shows a top view of the alignment mechanism of FIG. 19;

FIG. 21 shows a side view of the alignment mechanism of FIG. 19;

### DESCRIPTION OF THE ILLUSTRATED EMBODIMENTS

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in several ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted”, “connected”, “engaged” and variations thereof are used broadly and encompass both direct and indirect mountings, connections, supports, and couplings and are thus intended to include direct connections between two members without any other members interposed therebetween and indirect connections between members in which one or more other members are interposed therebetween. Further, “connected” and “engaged” are not restricted to physical or mechanical connections or couplings. Additionally, the words “lower”, “upper”, “upward”, “down” and “downward” designate directions in the drawings to which reference is made. The terminology includes the words specifically mentioned above, derivatives thereof, and words or similar import. It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

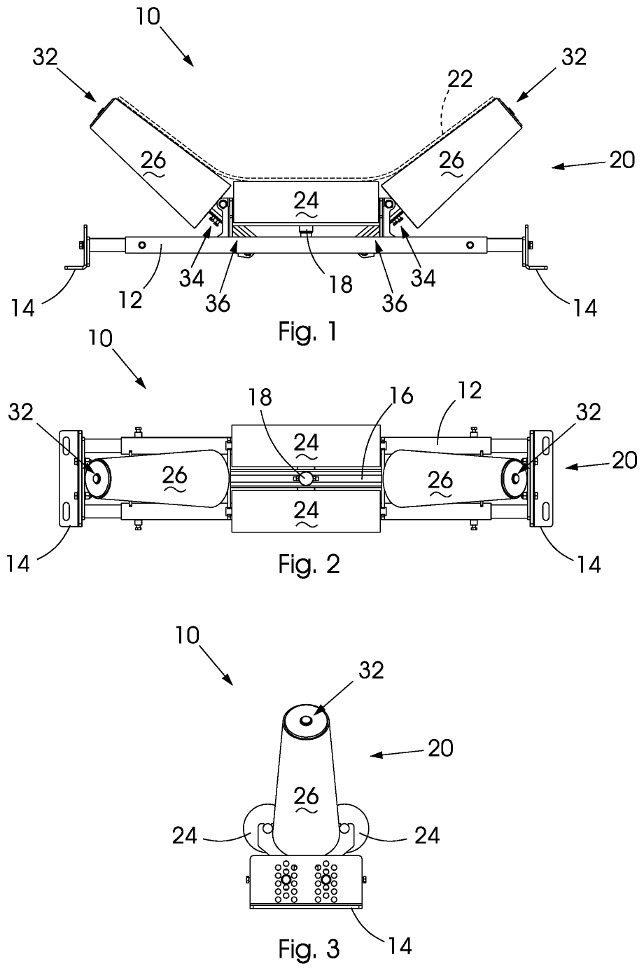

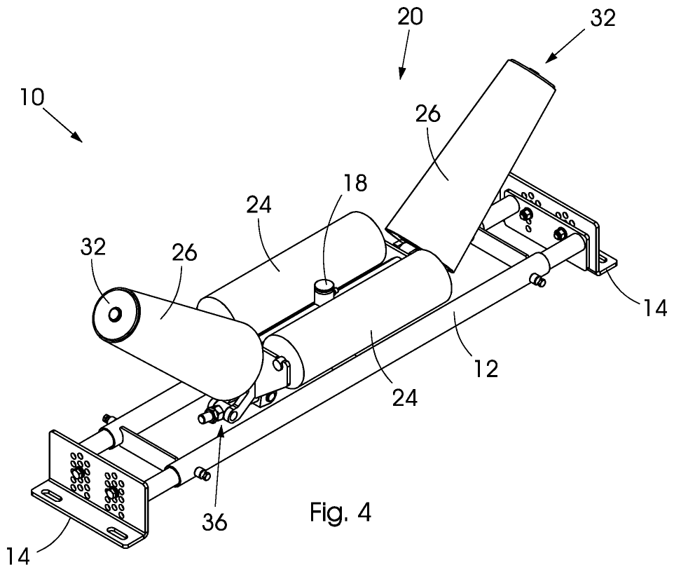

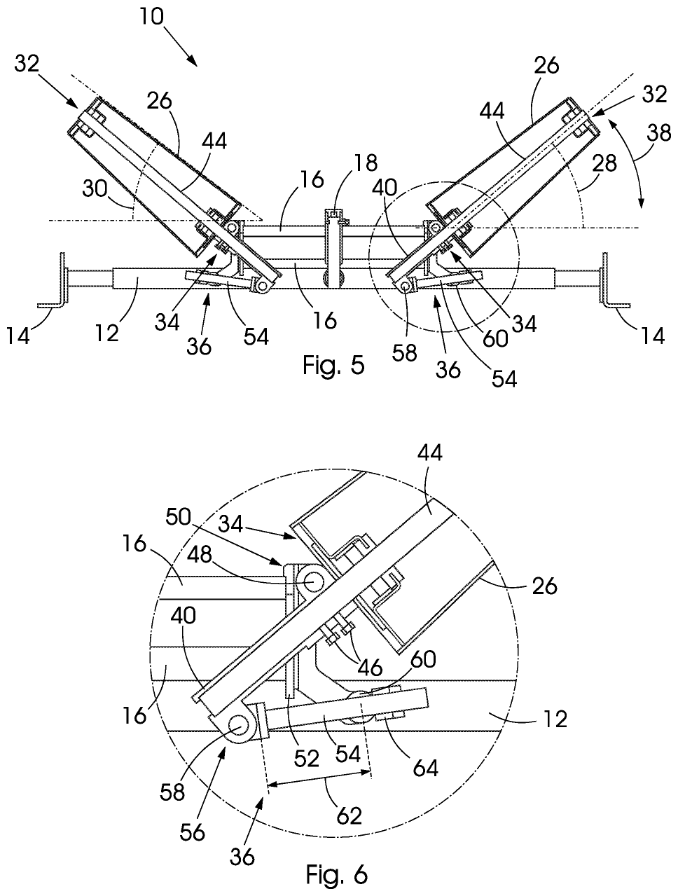

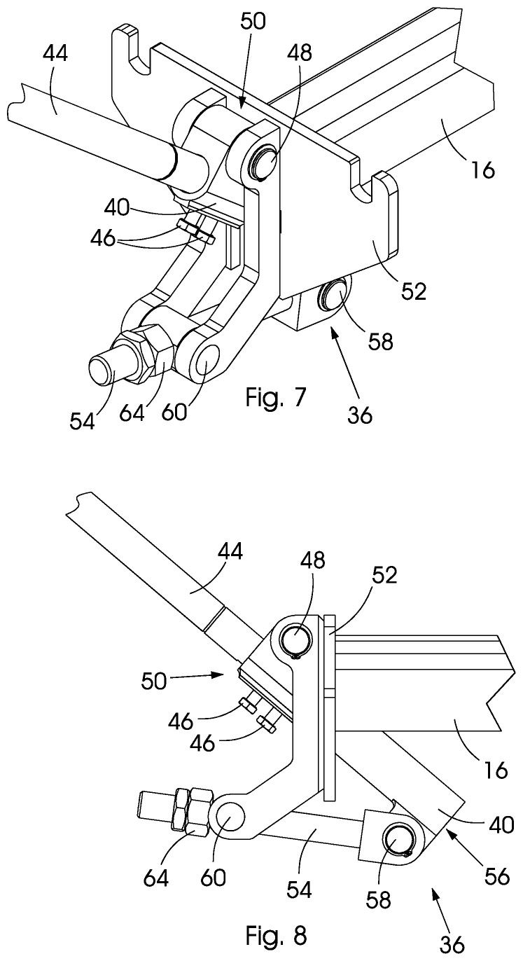

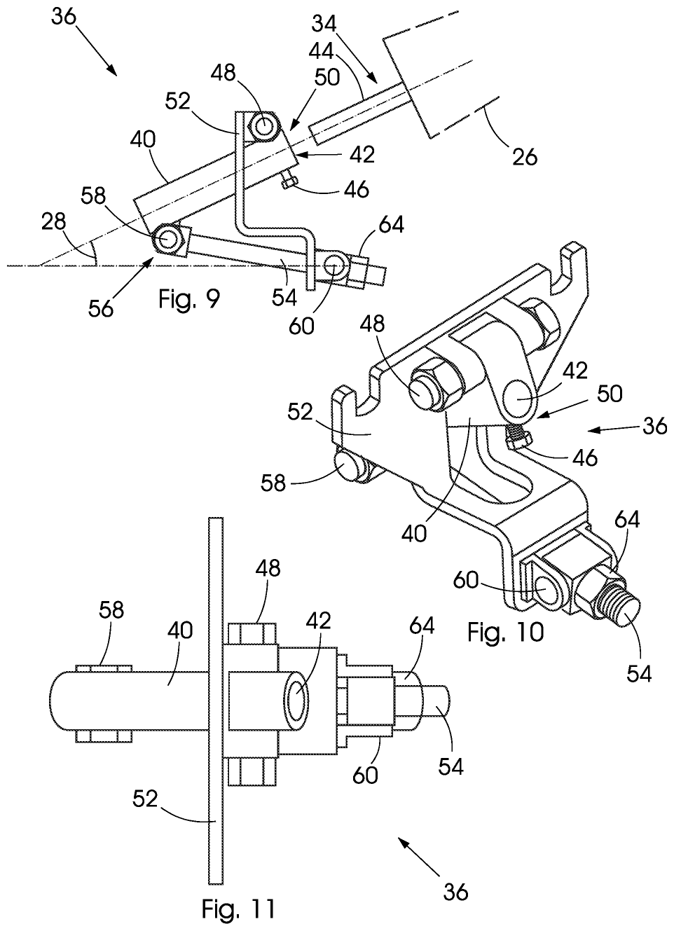

Referring to FIGS. 1 to 11, in which like numerals indicate like features, a non-limiting example of a conveyor alignment mechanism (or simply “alignment mechanism”), in accordance with the invention, is generally indicated by reference numeral 10.

The alignment mechanisms detailed herein are of a type in which outer or wing rollers are configured as steering rollers. Central rollers (if present) typically do not play an active or fundamental role in the steering or alignment of the belt. Therefore, alignment mechanisms with “steering” or “wing” rollers as discussed herein are distinguished from other types of alignment mechanism in which side rollers play a role as “activation rollers” and in which case a central roller plays an active or primary role in steering or alignment of the belt.

The alignment mechanism 10 is specifically configured as a trough conveyor alignment mechanism.

The alignment mechanism 10 comprises a mounting frame 12 with end mounting brackets 14 which, in use, mount to a conveyor belt frame structure (not shown). The mounting frame 12 is telescopically adjustable (in width) to facilitate use with various conveyor belt frame structure configurations.

The alignment mechanism 10 also comprises a substructure in the form of a subframe 16, which is pivotably mounted to the mounting frame 12 by means of a main pivot (or pivot post) 18.

A set of rollers (collectively referred to by reference numeral 20) is supported by the subframe 16. The set of rollers 20 operatively support a conveyor belt, indicated schematically by broken lines and reference numeral 22 in FIG. 1.

The set of rollers 20 typically comprises at least one, but preferably a pair of central rollers 24 and a pair of tapered wing rollers 26. The wing rollers 26 are configured as steering rollers, as discussed more fully below. The central rollers 24 are arranged to the front and rear (in a direction of travel of the belt 22) of the main pivot 18. The wing rollers 26 are arranged on either side of the pair of central rollers 24. The wing rollers 26 are arranged at an angle 28 relative to the central rollers 24 such that a troughing angle 30 is defined (the troughing angle 30 is slightly smaller than the wing roller angle 28, due to the taper of the wing rollers 26). Edge portions of the belt 22 are carried and supported by the wing rollers 26. Since the set of rollers 20 is wholly supported by the subframe 16, the complete set 20 is therefore pivotable about the main pivot 18. As is known in the art, if the belt 22 becomes misaligned in use, one edge of the belt 22 will ride up one of the wing rollers 26 and the other edge of the belt 22 will ride down the opposite wing roller 26. Since the wing rollers 26 are tapered, this puts an uneven force on the two wing rollers 26 which causes a moment about the main pivot 18, causing the subframe 16 to pivot or swing on the main pivot 18. This will in turn cause the alignment mechanism 10 (and in particular, the steering or wing rollers 26) to steer the belt 22 back to a central position in which the forces on the wing rollers 26 are substantially equalised and the subframe 16 is substantially perpendicular to the length or direction of travel of the belt 22.

Importantly, each wing roller 26 is mounted proximally relative to the subframe 16 (therefore towards a centre of the alignment mechanism or towards the main pivot 18) in outward-facing cantilevered fashion. Therefore, an outside-facing end (distal end) 32 of each wing roller 26 is unsupported and therefore, the wing rollers 26 are only supported relative to the subframe 16 at their lower or proximal ends 34.

It will readily be appreciated that arranging the wing rollers in cantilevered fashion:
i. reduces an overall footprint of the subframe 16, which makes fitting of hoods and other structures relative to the conveyor structure more viable, whilst reducing the probability of contact with, catching or pinching of persons or equipment proximate the conveyor structure;
ii. potentially reduces the overall mass of the subframe 16 (due the removal of outer support structures provided for supporting the outside-facing ends 32 of the wing rollers 26);
iii. removes heavy and outwardly projecting support and adjustment mechanisms thereby making the distal ends of subframe 16 and/or wing rollers 26 lighter (the weight distribution of the alignment mechanism is therefore shifted towards the axis of rotation [the main pivot 18]); and
iv. reduces a rotational inertia of the subframe 16 and set 20.

The present inventor has found that a reduction in rotational inertia as aforementioned improves the ability of the alignment mechanism 10 to steer the belt 22 when compared to prior art alignment mechanisms 10 not utilising such cantilevered arrangements. More particularly, a reduced rotational inertia facilitates a quicker pivoting response of the alignment mechanism 10 through its alignment arc. This results in a more responsive, quicker and more accurate reaction to misalignments (even slight misalignments) of the belt 22, which enhances steering and trackability. Put differently, a lower rotational inertia requires a lower moment about the main pivot 18 (caused by the unbalanced forces transferred to the wing rollers 26 as aforementioned) to steer the belt 22 back to a substantially central position.

As discussed in more detail below, the embodiments shown in FIGS. 1 to 11 have wing rollers 26 which are pivotably adjustable relative to the subframe 16. That said, it will be appreciated that the present disclosure is not limited to alignment mechanisms 10 with such pivotably adjustable wing rollers 26, and therefore also extends to configurations in which the wing rollers 26 are fixed in position relative to the subframe 16. Such a configuration is not shown in the figures nor discussed in more detail herein.

The pivotable adjustment of the wing rollers 26 is provided for, since not all trough conveyors or belts have the same configuration—that is—troughing angles 30 of different conveyor arrangements may differ. An angle adjustment mechanism 36 is incorporated into the support structure with which the wing roller 26 is supported in cantilevered fashion relative to the subframe, 16 for this purpose. The angle adjustment mechanism 36 therefore allows adjustment of the wing roller angle 28 which, in turn, results in an adjustment of the troughing angle 30. The angle adjustment mechanism 36 therefore facilitates adjustment of the wing rollers 26 in the direction of the arrow 38.

With specific reference to FIGS. 6 to 11, the angle adjustment mechanism 36 comprises a tubular bracket 40 with a central bore 42 within which a proximal portion of a shaft 44 of the wing roller 26 is received. At least one, but typically two grub screws 46 are used to fix the shaft 44 relative to the tubular bracket 40. The fit between the central bore 42 and the shaft 44 is relatively fine or tight.

The tubular bracket 40 is mounted relative to the subframe 16 by means of a first pivot 48. More particularly, the first pivot 48 is located towards a first end 50, that is, a distal or top end, of the tubular bracket 40. The first pivot 48 attaches to a plate 52 which forms part of the subframe 16. The tubular bracket 40 may therefore pivot about the first pivot 48 relative to the subframe 16.

The angle adjustment mechanism 36 furthermore comprises an adjustable link mechanism 54, which is pivotably fixed towards a second end 56, that is a proximal or lower end, of the tubular bracket 40 by means of a second pivot 58. The adjustable link mechanism 54 is furthermore supported relative to the subframe 16 (and more particularly, the plate 52) by means of a third pivot 60. The adjustable link mechanism 54 therefore extends between the second end 56 of the tubular bracket 40 and the subframe 16. The adjustable link mechanism 54 can slide relative to the third pivot 60, to adjust a distance between the second and third pivots (58, 60). An “effective length” 62 of the adjustable link mechanism 54 defined between the second and third pivots (58, 60) is therefore adjustable. Since the relative locations of the first and third pivots (48, 60) are fixed (both are fixed relative to the subframe 16), adjusting the effective length 62 causes the tubular bracket 40, and therefore the wing roller 26, to pivot about the first pivot 48.

The adjustable link mechanism 54 is releasably lockable in position (to lock the effective length 62 and therefore the wing roller 26). The adjustable link mechanism 54 takes the form of a threaded rod and the third pivot 60 is associated with a bore or bush through which the rod extends (and through which the rod can freely be displaced longitudinally). A position of the rod relative to the third pivot 60 (and therefore the effective length 62) can be locked by means of a stopper in the form of a locknut 64. By adjusting the locknut 64, the effective length 62 can very finely be adjusted, resulting in very fine adjustments of the wing roller angle 28 and the troughing angle 30.

Due to the configuration of the angle adjustment mechanism 36, the wing roller angle 28 can be adjusted between about zero degrees and about 65 degrees and may therefore be adjusted to any angle between (and including) those extremities. It will be appreciated that this represents a relatively large range of angular adjustment (compared to ranges of adjustment of prior art alignment mechanisms). This large range of angular adjustments and the ability to make fine or minor angular adjustments within said range provide important benefits and lend functionality to the alignment mechanism 10:
i. by being adjustable to about 0 degrees, the alignment mechanism 10 can be packaged very compactly, which eases transportability;
ii. a wide range of troughing angles 30 are now achievable with a single alignment mechanism 10, which removes the need to provide different alignment mechanism 10 models for different ranges of troughing angle, removes the need to custom-manufacture alignment mechanisms 10 to order and enables end-users to keep fewer stock or spare items;
iii. fine adjustments (in the order of one or two degrees) are sometimes required to enhance the functionality and effectiveness of the alignment mechanism.

It will be appreciated that the wing rollers 26 are arranged to pivot in a plane which is substantially perpendicular to a plane in which the subframe 16 is allowed to pivot about the main pivot 18. The wing rollers 26 are arranged to pivot in a plane which is substantially perpendicular or vertical relative to the surface on which the conveyor is supported, whereas the subframe pivots in a plane which is substantially horizontal relative to the surface on which the conveyor is supported.

It will be appreciated that the above description only provides one preferred example embodiment of the conveyor alignment mechanism 10 and that there may be many variations without departing from the spirit and/or the scope of the invention.

For example, the first, second and third pivots (48, 58, 60) typically take the form of nut and bolt assemblies extending through suitable bushes, but the use of alternative arrangements, such as pin and C-clips and the like would also be feasible.

In some implementations, a single central roller rather than two central rollers may be provided. In alternative implementations, the one or more central rollers may be replaced all together with one or more bearing plate(s) manufactured from a low-friction material (such as a polished metal or a low-friction polymer) (here it should again be noted that the central rollers in this type of alignment mechanism do not play an instrumental role in the steering of the belt).

A configuration where the central roller(s) 24 is not pivotable relative to the supporting frame 12 or about the main pivot 18 could also theoretically be possible (especially, given that the central roller 24 is not configured as a steering roller).

The adjustable link mechanism 54 and stopper may take other forms, such as an un-threaded rod with a number of longitudinally spaced holes through which a pin may be placed (as stopper). In such a case, the effective length 62 can only be adjusted in increments, and fine adjustments of the wing roller angle 28 would therefore not be possible. Some underlying principles as aforementioned will still be achievable with such a configuration, though. The adjustment mechanism 36 may take alternative forms, such as the adjustment mechanism 210 discussed below (with suitable adjustments to the design, where necessary).

Furthermore, different belt widths, conveyor speeds and load weights will determine the physical characteristics and strength required of the various components, including the angle adjustment mechanism. The invention is not therefore limited to the embodiments depicted in the drawings.

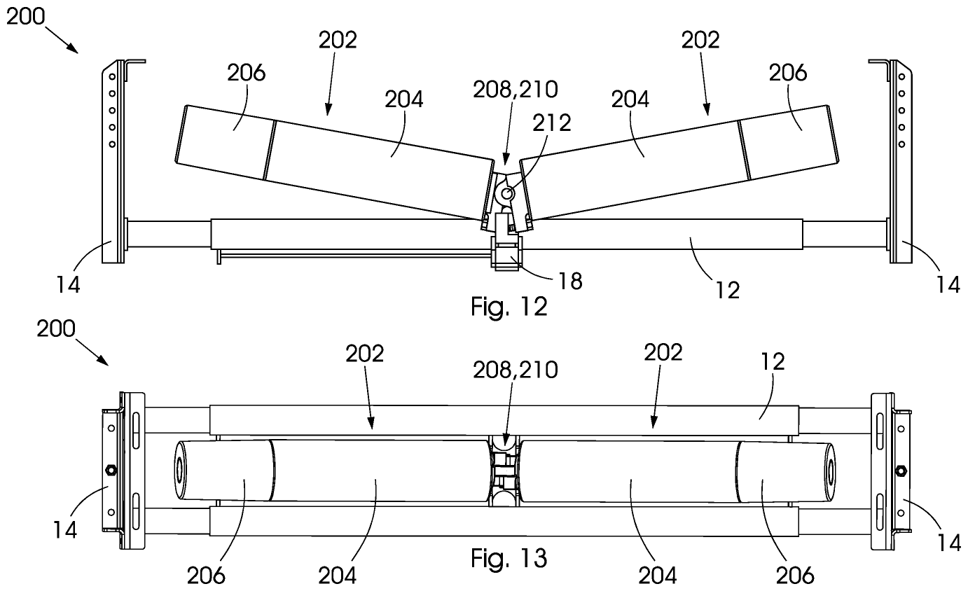

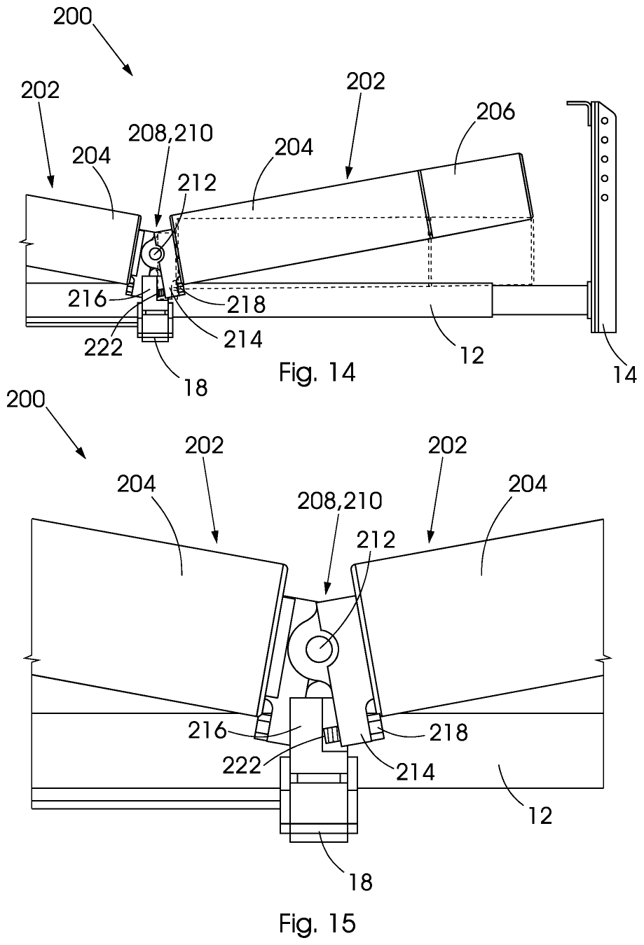

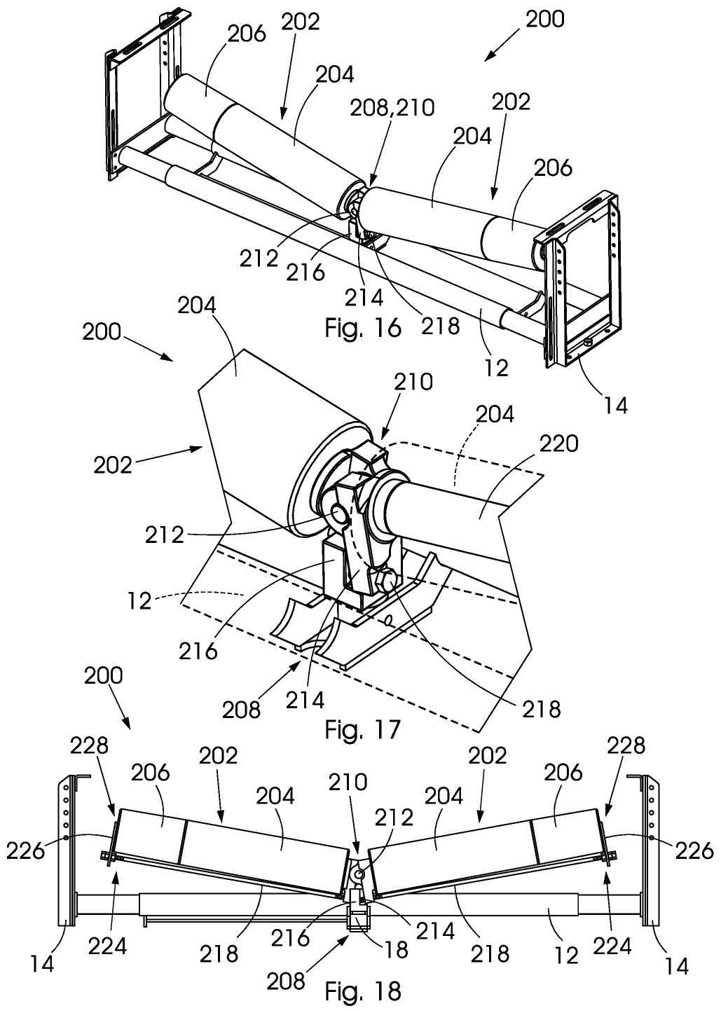

Turning next to FIGS. 12 to 18, an alternative form of alignment mechanism, more particularly taking the form of a return tracker or return alignment mechanism (again simply referred to as an “alignment mechanism”), is generally indicated by reference numeral 200. It will be appreciated that the alignment mechanism 200 may be used with belts configured in a flat or troughed configuration.

The alignment mechanism 200 of FIGS. 12 to 18 shares many components and functionalities with the alignment mechanism 10 of FIGS. 1 to 11, and like features will be indicated by like reference numerals.

The alignment mechanism 200 comprises two steering rollers 202, which have a substantially cylindrical main portion 204 and a tapered end portion 206. Here, the tapered end portions 206 play an instrumental role in the steering of the belt. It will be appreciated that the alignment mechanism 200 does not include central rollers or even central bearing plates.

The alignment mechanism 200 includes a substructure 208 (in this configuration, not taking the form of a subframe) and two angle adjustment mechanisms (one associated with each respective steering roll 202, and collectively indicated by reference numeral 210).

Each angle adjustment mechanism 210 comprises a first pivot 212, a lever 214, a base plate 216 and an adjustable member 218. The lever 214 is pivotable about the first pivot 212 and therefore relative to the substructure 208. The base plate 216 is fixed relative to the substructure 208. The adjustable member 218 extends between the lever 214 and the base plate 216. The shaft 220 of the respective steering roller 202 is fixed relative to the lever 214.

The adjustable member 218 takes the form of a threaded rod received within a threaded bore of the lever 214. A first end 222 of the adjustable member 218 bears against the base plate 216. Adjustment of the adjustable member 218 therefore pivotably adjusts the lever 214 relative to the base plate 216 and the steering roller relative to the substructure 208.

In some cases, and particularly as shown in FIG. 18, the threaded rod is elongate and extends longitudinally along the length of the steering roller 202. A second end 224 of the threaded rod 218 is now supported by a support plate 226 relative to a distal end 228 of the steering roller 202. The elongate rod 218 enables adjustment of an angle of the roller 202 from the side of the conveyor structure, which eases adjustment.

The alignment mechanism 200 again facilitates fine adjustments of the roller angle (not indicated). In particular, when it comes to return trackers, fine adjustments (in the order of one to two degrees are often very effective in ensuring proper contact of outer edge portions of the belt with the tapered end portions 206, thereby facilitating more effective tracking and alignment of the belt. Such fine adjustments are facilitated by the alignment mechanism 200. Also, the angle adjustment mechanism 210 allows the steering rollers 202 to be arranged in a flat configuration, or a V-configuration, depending on the specific application and requirements. It will be appreciated that many further advantages associated with the alignment mechanism 10, are also obtained by the alignment mechanism 200.

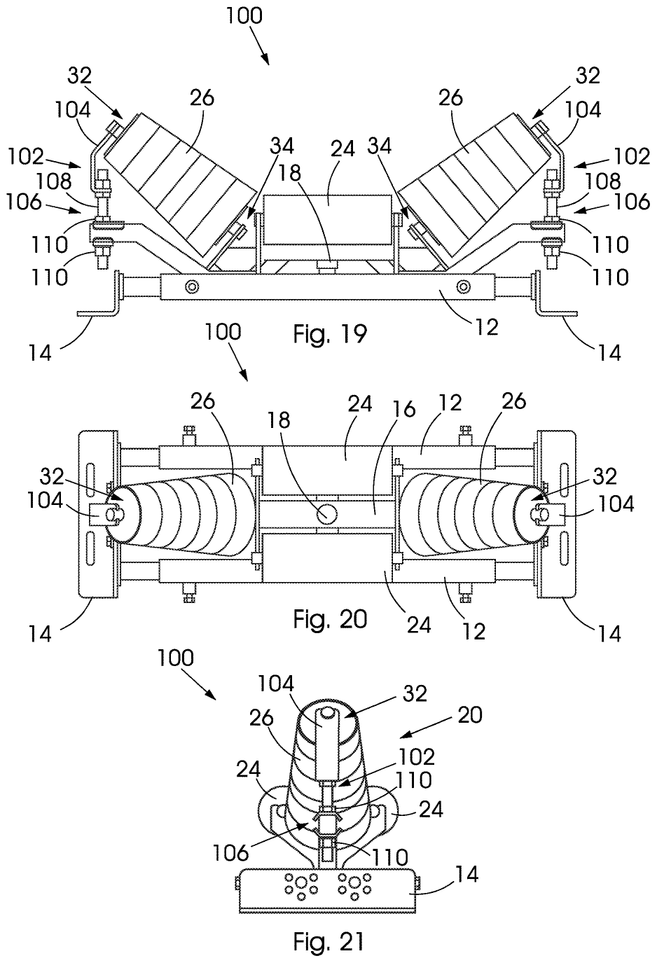

A further aspect of the invention is shown in FIGS. 19 to 21. Here, a further non-limiting example of a trough conveyor alignment mechanism (or simply “alignment mechanism”) is indicated by reference numeral 100. Since the alignment mechanisms (10 and 100) operate in substantially the same way, the manner in which the mechanisms work will not be discussed in detail. Like parts will be numbered the same.

Turning specifically to FIG. 19, it will be noted that the steering or wing rollers 26 are mounted and supported at both ends (proximal and distal) to a support mechanism-that is-not in cantilever-fashion. However, in this embodiment the upper or outside facing (distal) end 32 of the wing roller 26 is supported on a support bracket 102 which includes an angled support plate 104 with a slot at its upper end to receive the shaft 44 of the wing roller 26. This support plate 104 is connected to the subframe 16 by an adjustment mechanism 106 which is arranged substantially vertically (relative to the surface on which the conveyor is supported) and therefore configured to raise or lower the support plate 104 using a threaded rod 108 and nuts 110. By raising or lowering the support plate 104 the angle 28 of the wing roller 26 is changed.

One advantage of the adjustment mechanism shown in FIGS. 19 to 21 is that it will provide more support to the wing roller 26 which may be useful in heavy duty applications. Another advantage is that the adjustment mechanism does not extend laterally substantially beyond the edge of the mounting brackets 14.

A footprint (viewed in plan) of the subframe and pair of angle adjustment mechanisms falls within a footprint of the mounting frame (and in particular, the mounting brackets 14) viewed in plan. Thus, since conveyors are usually provided with a walkway on either side of the conveyor for maintenance purposes, the fact that the adjustment mechanisms are located inboard of the mounting brackets 14 means that snagging of maintenance crew by the adjustment mechanism as the crew moves past will be significantly reduced. Also, these compact alignment mechanisms can be installed within hooded or covered conveyors without having to make modifications to the hood or cover.

It will be appreciated that each of the alignment mechanisms discussed above, the steering or wing rollers are arranged in-line with the main pivot 18. As result, the tracking mechanisms may be used to align a belt travelling in a forwards or reverse direction.

It will be appreciated that the above description only provides example embodiments of particular aspects of the invention and that there may be many variations without departing from the spirit and/or the scope of the invention.

It will be easily understood from the present description that the particular features of the present invention, as generally described and illustrated in the figures, can be arranged and designed according to a wide variety of different configurations. In this way, the description of the present invention and the related figures are not provided to limit the scope of the invention but simply represent selected embodiments.

The skilled person will understand that the technical characteristics of a given embodiment can in fact be combined with characteristics of another embodiment, unless otherwise expressed or it is evident that these characteristics are incompatible. Also, the technical characteristics described one embodiment can be isolated from the other characteristics of this embodiment unless otherwise expressed.

1. A conveyor alignment mechanism, comprising a mounting frame for operatively mounting the conveyor alignment mechanism to a conveyor frame;
a substructure, pivotably mounted to the mounting frame by means of a main pivot;
a pair of steering rollers mounted relative to the substructure in outward-facing cantilevered fashion.

2. The conveyor alignment mechanism according to claim 1, wherein at least a portion of each of the steering rollers is tapered.

3. The conveyor alignment mechanism according to claim 1, wherein each steering roller is pivotably adjustable relative to the substructure.

4. The conveyor alignment mechanism according to claim 3, wherein each steering roller is mounted to the substructure by means of an angle adjustment mechanism.

5. The conveyor alignment mechanism according to claim 4, wherein each angle adjustment mechanism comprises a tubular bracket with a bore within which a shaft of the respective steering roller is operatively received and retained in cantilever fashion.

6. The conveyor alignment mechanism according to claim 5, wherein the shaft of the respective steering roller is fixed relative to the tubular bracket by means of at least a first grub screw.

7. The conveyor alignment mechanism according to claim 5, wherein, towards a first end thereof, the tubular bracket is pivotably mounted to the substructure by means of a first pivot.

8. The conveyor alignment mechanism according to claim 7, wherein an adjustable link mechanism extends between a second end of the tubular bracket and the substructure, wherein the adjustable link mechanism is pivotably fixed to both the tubular bracket and the substructure by means of a second and third pivot, respectively.

9. The conveyor alignment mechanism according to claim 8, wherein an effective length of the adjustable link mechanism is adjustable, to pivot the tubular bracket about the first pivot to adjust an angle of the tubular bracket relative to substructure.

10. The conveyor alignment mechanism according to claim 8, wherein the adjustable link mechanism comprises a threaded rod with a locking nut arrangement for releasably fixing a position of the adjustable link mechanism.

11. The conveyor alignment mechanism according to claim 3, wherein each steering roller is adjustable between about 0 degrees and 65 degrees relative to a plane in which the substructure is pivotable about the main pivot.

12. The conveyor alignment mechanism according to claim 1, further comprising at least a first central roller arranged between the pair of steering rollers.

13. The conveyor alignment mechanism according to claim 12, comprising two central rollers arranged on opposite sides of the main pivot.

14. The conveyor alignment mechanism according to claim 4, wherein each angle adjustment mechanism comprises:
a first pivot connected to the substructure and to a shaft of the respective steering roller;
a lever arranged pivotably relative to the substructure;
a base plate fixed relative to the substructure; and
an adjustable member extending between the lever and base plate.

15. The conveyor alignment mechanism according to claim 14, wherein the adjustable member comprises a threaded member received within a threaded bore of the lever and having a first end arranged to bear against the base plate.

16. The conveyor alignment mechanism according to claim 15, wherein the threaded member comprises an elongate member having a second end supported relative to a distal end of the respective steering roller.

17. The conveyor alignment mechanism according to claim 3, wherein each steering roller is configured to be pivotably adjustable in a plane substantially perpendicular to a plane in which the substructure is pivotable about the main pivot.

18-20. (canceled)

21. A conveyor, comprising
a main conveyor frame;
a conveyor alignment mechanism according to claim 1 mounted to the main conveyor frame; and
a belt supported at least partially on the conveyor alignment mechanism.
